(19) United States
(12) Patent Application Publication
(10) Pub. No.: US 2009/0174157 A1
(43) Pub. Date: Jul. 9, 2009

(54) Tool connecting device

(75) Inventor: Sheng Ming Chang, Taichung Hsien (TW)

Correspondence Address: CHARLES E. BAXLEY, ESQUIRE, 90 JOHN STREET, SUITE 309, NEW YORK, NY, 10038, US

(73) Assignee: Hsin Ying Enterprise Co., Ltd.

(21) Appl. No.: 12/008,022

(22) Filed: Jan. 8, 2008

(51) Int. Cl. B23B 31/00; B23B 31/28

(52) U.S. Cl. 279/99; 279/128; 279/9.1

(57) ABSTRACT

A tool connecting device includes a mandrel having a non-circular engaging hole for receiving a tool member, and having an outer peripheral recess for forming a peripheral shoulder, and a sleeve slidably engaged onto the mandrel and having a retaining ring frictionally engaged in the sleeve for slidably engaging with the peripheral recess of the mandrel and for limiting the sleeve to slide relative to the mandrel, the retaining ring is engageable with the peripheral shoulder of the mandrel for preventing the sleeve from being disengaged from the mandrel, and the tool member is extendible out of the sleeve for engaging with a fastener. The sleeve may limit the tool member to extend out of the sleeve.

### BACKGROUND OF THE INVENTION

1. Field of the Invention

The present invention relates to a tool connecting device, and more particularly to a tool connecting device including an adjustable structure for connecting a tool member to a mandrel to allow the tool member to be selectively secured to the mandrel and rotated in concert with the mandrel or to be rotated or driven by the mandrel.

2. Description of the Prior Art

Typical tool connecting devices comprise a driving shank or bushing having a non-circular chamber formed therein for engaging with a driven tool member or a fastener, and an outer sleeve slidably attached onto the bushing for engaging with the driven tool member or fastener and for stably anchoring or securing the driven tool member or fastener to the bushing.

For example, U.S. Pat. No. 4,629,375 to Lieser discloses one of the typical chucks for tool shanks or screwdriver bits and comprising an outer sleeve and an end ring slidably attached onto a driving bushing for engaging with the driven tool member or fastener and for stably anchoring or securing the driven tool member or fastener to the bushing.

However, the sliding movement between the outer sleeve and the end ring and the driven tool member may not be adjusted, or the outwardly extending status of the driven tool member relative to the outer sleeve may not be adjusted or predetermined such that the fasteners may have a good chance to be over-rotated or damaged by the driven tool member.

U.S. Pat. No. 5,934,384 to Wang discloses another typical transmission shaft and bit mounting arrangement of a motor-driven hand drill also comprising a chuck slidably attached onto a transmission shaft for engaging with the driven tool member or fastener and for stably anchoring or securing the driven tool member or fastener to the transmission shaft.

However, similarly, the sliding movement between the chuck and the driven tool member may not be adjusted, or the outwardly extending status of the driven tool member relative to the chuck may not be adjusted or predetermined such that the fasteners may have a good chance to be over-rotated or damaged by the driven tool member.

U.S. Pat. No. 6,311,989 to Rosanwo discloses a further typical chuck for screwdriver inserts also comprising an actuating sleeve slidably attached onto a rod for engaging with the driven tool member or fastener and for stably anchoring or securing the driven tool member or fastener to the rod.

However, similarly, the sliding movement between the actuating sleeve and the driven tool member may not be adjusted, or the outwardly extending status of the driven tool member relative to the actuating sleeve may not be adjusted or predetermined such that the fasteners may have a good chance to be over-rotated or damaged by the driven tool member.

U.S. Pat. No. 6,530,299 to Liu discloses a still further typical joint adapter for a power drill screw driver also comprising a slide socket slidably attached onto a driving shaft for engaging with the driven tool member or fastener and for stably anchoring or securing the driven tool member or fastener to the driving shaft, and the slide socket may be moved or adjusted relative to the driving shaft and the driven tool member.

However, the slide socket may only be slide relative to the driving shaft and the driven tool member, but may not be adjusted and retained at the required position relative to the driving shaft and the driven tool member.

U.S. Pat. No. 6,953,196 to Huang discloses a further typical non-inflation adapter also comprising an annular sleeve slidably attached onto a tubular adapter for engaging with the driven tool member or fastener and for stably anchoring or securing the driven tool member or fastener to the tubular adapter.

However, similarly, the sliding movement between the annular sleeve and the driven tool member may not be adjusted, or the outwardly extending status of the driven tool member relative to the annular sleeve may not be adjusted or predetermined such that the fasteners may have a good chance to be over-rotated or damaged by the driven tool member.

U.S. Pat. No. 6,973,858 to Huang discloses a further typical socket assembly also comprising an outer sleeve slidably attached onto an inner sleeve for engaging with the driven tool member or fastener and for stably anchoring or securing the driven tool member or fastener to the inner sleeve.

However, similarly, the sliding movement between the outer sleeve and the driven tool member may not be adjusted, or the outwardly extending status of the driven tool member relative to the outer sleeve may not be adjusted or predetermined such that the fasteners may have a good chance to be over-rotated or damaged by the driven tool member.

The present invention has arisen to mitigate and/or obviate the afore-described disadvantages of the conventional tool connecting devices.

### SUMMARY OF THE INVENTION

The primary objective of the present invention is to provide a tool connecting device including an adjustable structure for connecting a tool member to a mandrel to allow the tool member to be selectively secured to the mandrel and rotated in concert with the mandrel or to be rotated or driven by the mandrel.

The other objective of the present invention is to provide a tool connecting device including an adjustable structure for adjusting an outwardly extending status of the tool member relative to an outer sleeve and for predetermining the outwardly extending position of the tool member relative to the outer sleeve.

In accordance with one aspect of the invention, there is provided a tool connecting device comprising a mandrel including a non-circular engaging hole formed in a first end thereof for receiving a tool member therein, and including a cavity formed in the mandrel and communicating with the engaging hole of the mandrel for receiving a magnetic member which attracts the tool member to the mandrel, and including a peripheral recess formed in an outer peripheral portion of the mandrel for forming a peripheral shoulder, and a sleeve slidably engaged onto the first end of the mandrel and including a retaining ring engaged in an inner end of the sleeve for slidably engaging with the peripheral recess of the mandrel and for limiting the sleeve to slide relative to the mandrel, the retaining ring being engageable with the peripheral shoulder of the mandrel for preventing the sleeve from being disengaged from the mandrel, and the tool member being extendible out of the sleeve for engaging with a fastener, and the retaining ring being made of a material for frictionally engaging with the mandrel and for adjustably securing and maintaining the sleeve at a selected position relative to the mandrel.

The mandrel includes a barrel attached onto the magnetic member and frictionally engaged with the mandrel for securing the magnetic member in the mandrel.

The sleeve includes a magnetic ring attached to a second end of the sleeve for attracting the fastener to the sleeve and the tool member.

The sleeve includes a shielding member attached to the second end of the sleeve and disposed beside the magnetic ring for concentrating the magnetic ring to attract the fastener to the sleeve and the tool member.

The mandrel includes a positioning device for adjustably anchoring the sleeve to the mandrel at the selected position and for determining an outwardly extending position of the tool member relative to the sleeve.

The positioning device includes at least one positioning member attached to the mandrel for selectively engaging with the sleeve and for anchoring the sleeve to the mandrel at the selected position.

The mandrel includes an outer thread formed in the outer peripheral portion of the mandrel, and the positioning member includes an inner thread for engaging with the outer thread of the mandrel and for adjusting the positioning member relative to the mandrel.

The positioning device includes a second positioning member attached to the mandrel and engageable with the positioning member for locking the positioning member to the mandrel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tool connecting device in accordance with the present invention, in which a portion of the outer sleeve has been cut off for showing an inner structure of the tool connecting device;

FIG. 2 is a partial cross sectional view of the tool connecting device taken along lines 2-2 of FIG. 1;

FIG. 3 is a partial cross sectional view similar to FIG. 2 illustrating the operation of the tool connecting device;

FIG. 4 is a perspective view similar to FIG. 1 illustrating the other arrangement of the tool connecting device;

FIG. 5 is an exploded view of the tool connecting device as shown in FIG. 4;

FIG. 6 is a partial cross sectional view of the tool connecting device taken along lines 6-6 of FIG. 4;

FIG. 7 is a partial cross sectional view similar to FIG. 6 illustrating the operation of the tool connecting device as shown in FIGS. 4-6; and

FIG. 8 is a further partial cross sectional view similar to FIGS. 3 and 7 illustrating the further arrangement or application of the tool connecting device.

### DETAILED DESCRIPTION OF THE PREFERRED EMBODIMENT

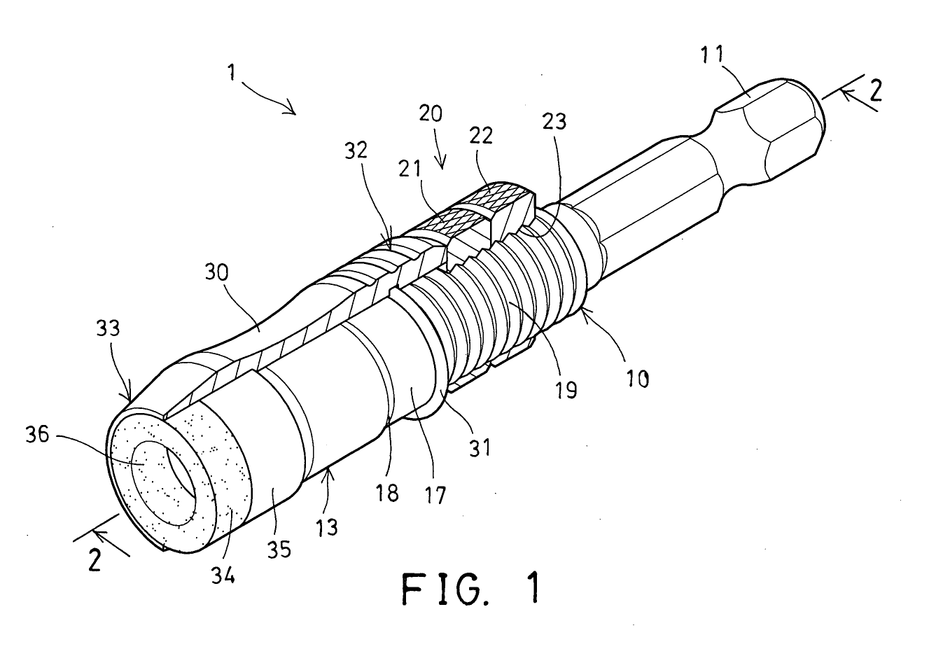

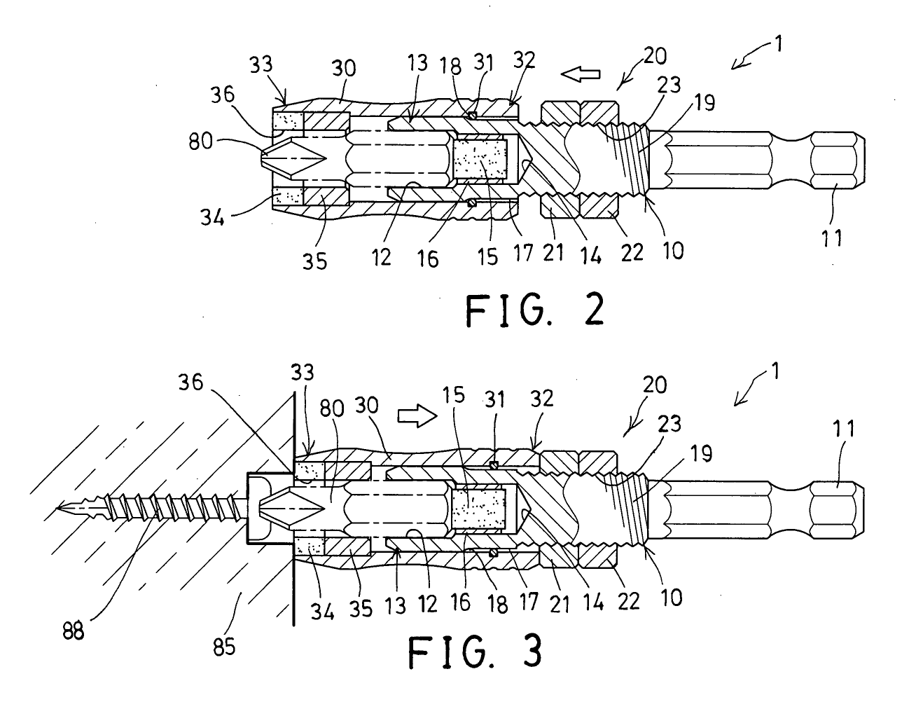

Referring to the drawings, and initially to FIGS. 1 and 2, a tool connecting device 1 in accordance with the present invention comprises a mandrel 10 including a stem 11 provided or extended on one end thereof for coupling to various driving tools (not shown), such as wrenches, power tools, tool extensions, etc., and including a non-circular engaging hole 12, such as a hexagonal engaging hole 12 formed in the other end 13 thereof for receiving a tool member 80 therein (FIGS. 2, 3), and including a cavity 14 formed in the inner portion thereof and communicating with the engaging hole 12 thereof for receiving a magnetic attracting or holding member 15 therein which may attract and retain the tool member 80 to the mandrel 10 (FIGS. 2, 3).

It is preferable, but not necessarily that the mandrel 10 further includes a barrel 16 attached or engaged onto the magnetic attracting or holding member 15 and engaged into the cavity 14 of the mandrel 10 and having a serrated outer structure for frictionally engaging with the mandrel 10 and for solidly anchoring or securing the magnetic attracting or holding member 15 in the mandrel 10. The mandrel 10 further includes a peripheral recess 17 formed in the outer peripheral portion of the mandrel 10 for forming a peripheral shoulder 18, and includes an outer thread 19 also formed in the outer peripheral portion of the mandrel 10 for threading or engaging with a positioning means or device 20 and for adjustably attaching the positioning means or device 20 to the mandrel 10.

For example, the positioning means or device 20 may include one or more (such as two) positioning members 21, 22 each having an inner thread 23 formed therein for threading or engaging with the outer thread 19 of the mandrel 10 and for allowing the positioning members 21, 22 to be moved or adjusted and positioned on the mandrel 10 at the selected positions and for allowing the positioning members 21, 22 to be moved or adjusted toward or away from the tool member 80 and/or the peripheral shoulder 18 of the mandrel 10. The positioning members 21, 22 may be engaged with each other for locking or securing to the mandrel 10. A control ferrule or outer sleeve 30 is slidably engaged onto the other end 13 of the mandrel 10 and includes a clamping or retaining ring 31 engaged in one end or inner end 32 of the sleeve 30 for slidably engaging with the peripheral recess 17 of the mandrel 10 and for limiting the sleeve 30 to slide relative to the mandrel 10. The retaining ring 31 is made of rubber or resilient materials for frictionally engaging with the mandrel 10 and for adjustably securing or maintaining the sleeve 30 at the selected position relative to the mandrel 10.

In operation, as shown in FIGS. 2 and 3, the retaining ring 31 of the sleeve 30 may be selectively engaged with the peripheral recess 17 of the mandrel 10 (FIG. 2) for limiting the outwardly extending or movement of the sleeve 30 relative to the other end 13 of the mandrel 10, and the inner end 32 of the sleeve 30 may be selectively engaged with the positioning members 21, 22 of the positioning means or device 20 (FIG. 3) for predetermining the outwardly extending position of the sleeve 30 relative to the mandrel 10, and also for predetermining the outwardly extending position of the tool member 80 relative to the sleeve 30, or for predetermining the engagement of the tool member 80 into a workpiece 85 to rotate or drive a fastener 88, or for predetermining the engagement of the fastener 88 into the workpiece 85 with the tool member 80.

As shown in FIG. 3, the other end or outer end 33 of the sleeve 30 may be selectively engaged with the workpiece 85 and the inner end 32 of the sleeve 30 may be selectively engaged with the positioning members 21, 22 of the positioning means or device 20 when the tool member 80 is forced onto or toward the workpiece 85, and the extension of the tool member 80 out of the outer end 33 of the sleeve 30 may be adjusted or determined by the adjustment of the positioning members 21, 22 of the positioning means or device 20 along or relative to the mandrel 10, in order to prevent the fastener 88 from being over-rotated or damaged by the tool member 80. The sleeve 30 may further include a magnetic ring 34 attached or engaged into the outer end 33 of the sleeve 30 for attracting the fastener 88 to the sleeve 30 and the tool member 80.

The sleeve 30 may further include an insulating or shielding member 35 also engaged into the outer end 33 of the sleeve 30 and disposed beside the magnetic ring 34, and facing toward or disposed closer to the sleeve 30, and made of magnetic insulating materials for preventing the magnetic ring 34 from acting onto the sleeve 30 and for concentrating the magnetic ring 34 to act onto and to attract the fastener 88 to the sleeve 30 and the tool member 80. The magnetic ring 34 and the insulating or shielding member 35 each may include a bore 36 formed therein for slidably receiving or engaging with the tool member 80 and for allowing the tool member 80 to be extended out through the bores 36 of the magnetic ring 34 and the insulating or shielding member 35.

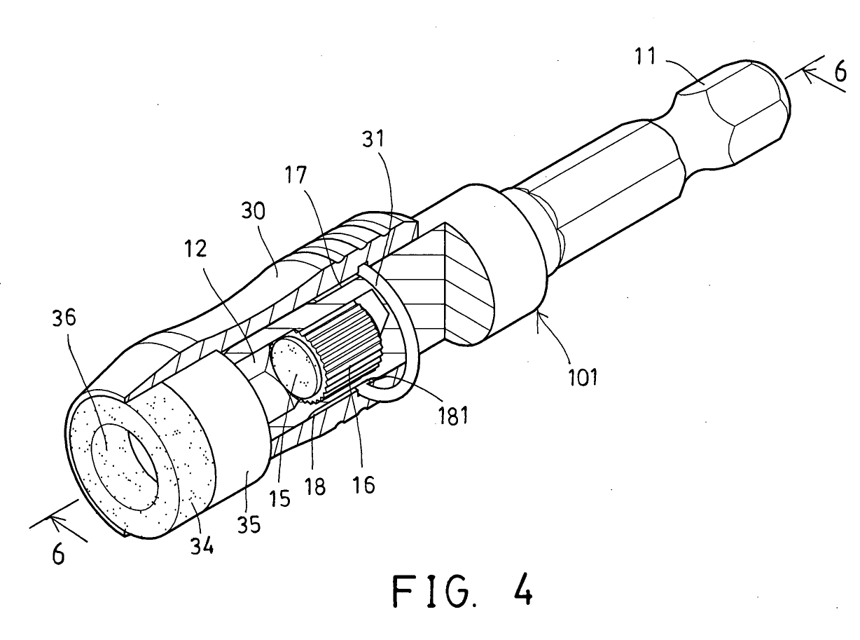

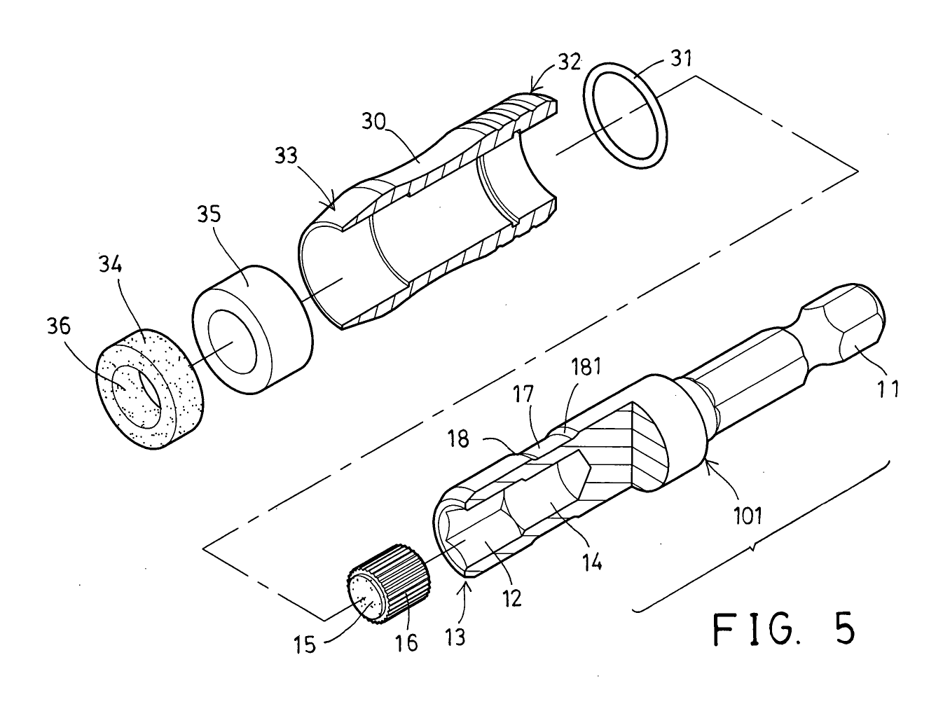

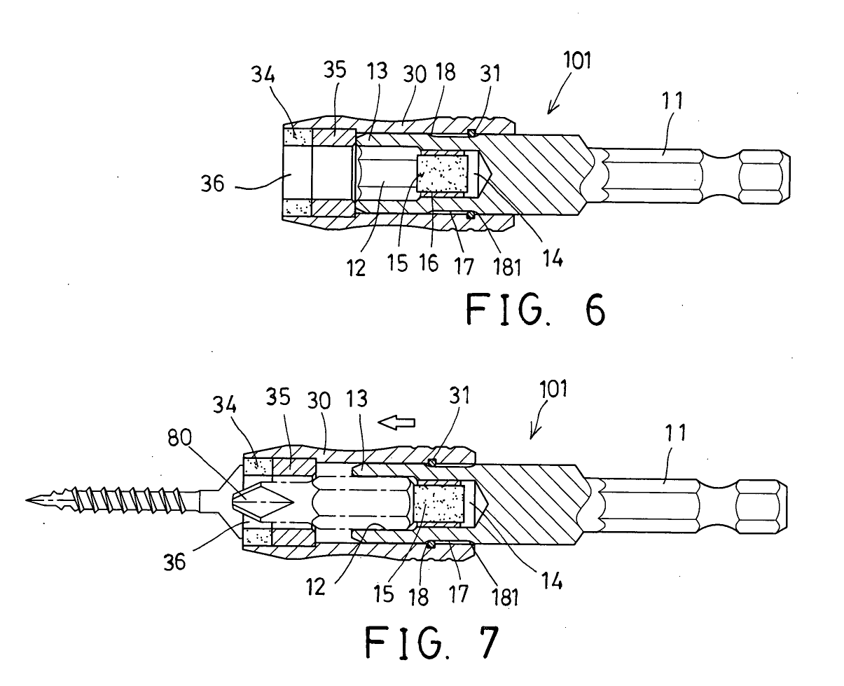

Alternatively, as shown in FIGS. 4-7, the mandrel 101 may include a peripheral recess 17 formed in the outer peripheral portion of the mandrel 101 for forming two peripheral shoulders 18, 181, or for being defined by or between the two peripheral shoulders 18, 181, or may include the two peripheral shoulders 18, 181 for forming the peripheral recess 17 between the two peripheral shoulders 18, 181, and the retaining ring 31 of the sleeve 30 may also be selectively engaged with the peripheral recess 17 of the mandrel 101 (FIGS. 6, 7) for limiting the outwardly extending or movement of the sleeve 30 relative to the other end 13 of the mandrel 101, and the retaining ring 31 of the sleeve 30 may be engaged with either of the two peripheral shoulders 18, 181 of the mandrel 101 for limiting the sleeve 30 to slide relative to the mandrel 101.

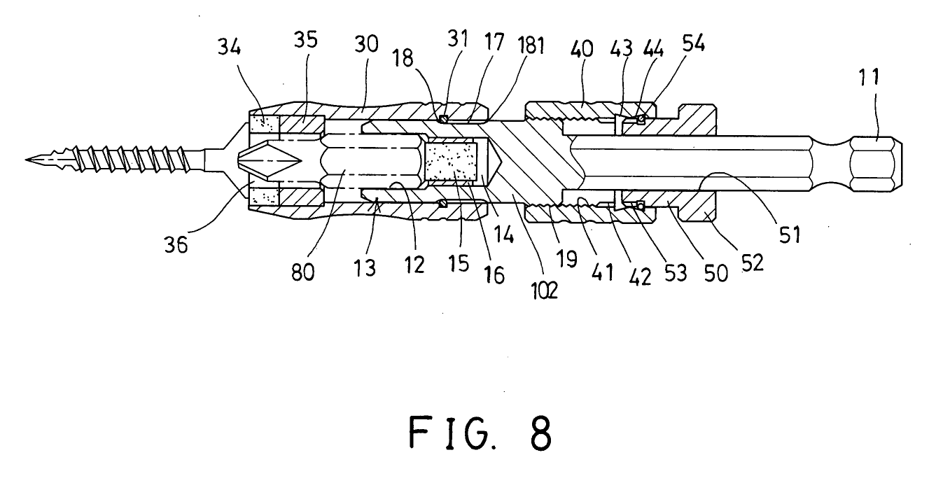

Further alternatively, as shown in FIG. 8, the mandrel 102 may further include, in addition to the two peripheral shoulders 18, 181 of the mandrel 102, an outer thread 19 formed in the outer peripheral portion of the mandrel 102, and may further include a control ferrule 40 having an inner thread 41 formed therein for threading or engaging with the outer thread 19 of the mandrel 102 and for allowing the control ferrule 40 to be moved or adjusted and positioned on the mandrel 102 at the selected positions and for allowing the control ferrule 40 to be moved or adjusted toward or away from the tool member 80 and/or the peripheral shoulders 18, 181 of the mandrel 102. The control ferrule 40 further includes a number of teeth 42 and two ratchet peripheral recesses 43, 44 formed therein.

An anchoring device 50 is further provided and slidably attached onto the mandrel 102, for example, the anchoring device 50 includes a non-circular compartment 51 formed therein for slidably receiving or engaging with the non-circular engaging hole 12 of the mandrel 102 and for preventing the anchoring device 50 from being rotated relative to the mandrel 102, and includes an enlarged engaging portion 52 for being engaged with a driving tool (not shown) and for allowing the anchoring device 50 to be rotated or driven by the driving tool. The anchoring device 50 is slidably engageable into the control ferrule 40 and includes a number of teeth 53 for selectively engaging with the teeth 42 of the control ferrule 40 and for selectively anchoring or positioning the control ferrule 40 to the mandrel 102, and also for selectively preventing the control ferrule 40 and the anchoring device 50 from being rotated relative to the mandrel 102.

The anchoring device 50 further includes a clamping or retaining ring 54 engaged onto the outer peripheral portion thereof for selectively engaging with either of the ratchet peripheral recesses 43, 44 of the control ferrule 40 and for limiting the control ferrule 40 to slide relative to the anchoring device 50, and/or for maintaining the teeth 42, 53 of the control ferrule 40 and the anchoring device 50 in engagement with each other or in disengagement from each other. In operation, the control ferrule 40 may also be selectively engaged with the sleeve 30 for limiting the outwardly extending or movement of the sleeve 30 to slide relative to the control ferrule 40 and the tool member 80, and the control ferrule 40 and the anchoring device 50 may adjust the outwardly extending or movement of the sleeve 30 relative to the mandrel 102, and the tool member 80.

Accordingly, the tool connecting device in accordance with the present invention includes an adjustable structure for connecting a tool member to a mandrel to allow the tool member to be selectively secured to the mandrel and rotated in concert with the mandrel or to be rotated or driven by the mandrel, and for adjusting an outwardly extending status of the tool member relative to an outer sleeve and for predetermining the outwardly extending position of the tool member relative to the outer sleeve.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool connecting device comprising:
a mandrel including a non-circular engaging hole formed in a first end thereof for receiving a tool member therein, and including a cavity formed in said mandrel and communicating with said engaging hole of said mandrel for receiving a magnetic member which attracts the tool member to said mandrel, and including a peripheral recess formed in an outer peripheral portion of said mandrel for forming a peripheral shoulder, and
a sleeve slidably engaged onto said first end of said mandrel and including a retaining ring engaged in an inner end of said sleeve for slidably engaging with said peripheral recess of said mandrel and for limiting said sleeve to slide relative to said mandrel, said retaining ring being engageable with said peripheral shoulder of said mandrel for preventing said sleeve from being disengaged from said mandrel, and the tool member being extendible out of said sleeve for engaging with a fastener, and said retaining ring being made of a material for frictionally engaging with said mandrel and for adjustably securing and maintaining said sleeve at a selected position relative to said mandrel.

2. The tool connecting device as claimed in claim 1, wherein said mandrel includes a barrel attached onto said magnetic member and frictionally engaged with said mandrel for securing said magnetic member in said mandrel.

3. The tool connecting device as claimed in claim 1, wherein said sleeve includes a magnetic ring attached to a second end of said sleeve for attracting the fastener to said sleeve and the tool member.

4. The tool connecting device as claimed in claim 3, wherein said sleeve includes a shielding member attached to said second end of said sleeve and disposed beside said magnetic ring for concentrating said magnetic ring to attract the fastener to said sleeve and the tool member.

5. The tool connecting device as claimed in claim 1, wherein said mandrel includes a positioning device for adjustably anchoring said sleeve to said mandrel at the selected position and for determining an outwardly extending position of the tool member relative to said sleeve.

6. The tool connecting device as claimed in claim 5, wherein said positioning device includes at least one positioning member attached to said mandrel for selectively engaging with said sleeve and for anchoring said sleeve to said mandrel at the selected position.

7. The tool connecting device as claimed in claim 6, wherein said mandrel includes an outer thread formed in the outer peripheral portion of said mandrel, and said at least one positioning member includes an inner thread for engaging with said outer thread of said mandrel and for adjusting said at least one positioning member relative to said mandrel.

8. The tool connecting device as claimed in claim 6, wherein said positioning device includes a second positioning member attached to said mandrel and engageable with said at least one positioning member for locking said at least one positioning member to said mandrel.
